(19) United States
(12) Patent Application Publication
(10) Pub. No.: US 2026/0235405 A1
(43) Pub. Date: Aug. 13, 2026

(54) SYSTEMS AND METHODS FOR FIELD SETUP OF GAS LEAK MONITORING TOOLS

(71) Applicant: Schlumberger Technology Corporation, Sugar Land, TX (US)

(72) Inventors: Burc Simsek, Houston, TX (US); Raphael Gadot, Houston, TX (US); Mathieu Dauphin, Cambridge, MA (US); Viraj Mantri, Rosharon, TX (US); Robert Sanders, Houston, TX (US)

(21) Appl. No.: 19/047,920

(22) Filed: Feb. 7, 2025

(51) Int. Cl. G01C 17/38; G01C 17/28

(52) U.S. Cl. CPC G01C 17/38; G01C 17/28

(57) ABSTRACT

A tangible and non-transitory machine readable medium including instructions to operate a monitoring tool in a setup mode and a normal operational mode. The monitoring tool includes one or more sensors, a power supply, and a controller coupled to the one or more sensors and the power supply, wherein the controller has a processor, a memory, and instructions stored on the memory and executable by the processor. The setup mode is configured to collect sensor data during a first rotational movement of the monitoring tool about a central axis of a mount, obtain calibration data based on the sensor data, calibrate the monitoring tool based on the calibration data, and identify a true North orientation of the monitoring tool during a second rotational movement of the monitoring tool about the central axis of the mount.

### BACKGROUND

The present disclosure relates generally to a system and method for setting up a monitoring tool, such as a gas leak monitoring tool, in a facility.

A variety of facilities are susceptible to fugitive emissions or leaks of greenhouse gases (GHG). For example, some facilities may store, transfer, and/or process hydrocarbons (e.g., oil and gas). Unfortunately, GHGs may leak from various equipment in the facility. A monitoring tool may be used to monitor for leaks of the GHGs in the facility. The monitoring tool may typically operate in a dormant mode to conserve power. However, the monitoring tool may periodically wake up and collect sensor data. Due to the dormant mode, the monitor tool may be particularly difficult to interact with during field operations, such as an initial setup of the monitoring tool. As a result, a need exists for a field setup mode for monitoring tools typically operating in a dormant mode.

### BRIEF DESCRIPTION

A summary of certain embodiments described herein is set forth below. It should be noted that these aspects are presented merely to provide the reader with a brief summary of these certain embodiments and that these aspects are not intended to limit the scope of this disclosure.

In certain embodiments, a system includes a monitoring tool having one or more sensors, a power supply, and a controller coupled to the one or more sensors and the power supply. The controller has a processor, a memory, and instructions stored on the memory and executable by the processor to operate in a setup mode and a normal operational mode. The setup mode is configured to collect sensor data during a first rotational movement of the monitoring tool about a central axis of a mount, obtain calibration data based on the sensor data, calibrate the monitoring tool based on the calibration data, and identify a true North orientation of the monitoring tool during a second rotational movement of the monitoring tool about the central axis of the mount.

In certain embodiments, a tangible and non-transitory machine readable medium includes instructions to operate a monitoring tool in a setup mode and a normal operational mode. The monitoring tool includes one or more sensors, a power supply, and a controller coupled to the one or more sensors and the power supply, wherein the controller has a processor, a memory, and instructions stored on the memory and executable by the processor. The setup mode is configured to collect sensor data during a first rotational movement of the monitoring tool about a central axis of a mount, obtain calibration data based on the sensor data, calibrate the monitoring tool based on the calibration data, and identify a true North orientation of the monitoring tool during a second rotational movement of the monitoring tool about the central axis of the mount.

In certain embodiments, a method includes operating a monitoring tool in a setup mode and a normal operational mode. The monitoring tool includes one or more sensors, a power supply, and a controller coupled to the one or more sensors and the power supply, wherein the controller has a processor, a memory, and instructions stored on the memory and executable by the processor. The setup mode is configured to collect sensor data during a first rotational movement of the monitoring tool about a central axis of a mount, obtain calibration data based on the sensor data, calibrate the monitoring tool based on the calibration data, and identify a true North orientation of the monitoring tool during a second rotational movement of the monitoring tool about the central axis of the mount.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of a facility having a plurality of sensors to monitor gas leaks throughout the facility.

FIG. 2 is a perspective view of an embodiment of a sensor of FIG. 1, further illustrating the sensor having a monitoring tool coupled to an installation pole.

FIG. 3 is a block diagram of an embodiment of the sensor of FIGS. 1 and 2, further illustrating components within a body of the monitoring tool.

FIG. 4 is a flow chart of an embodiment of a process of installing the sensor (e.g., monitoring tool) of FIGS. 1-3 according to a field setup mode.

FIG. 5 is a flow chart of an embodiment of a calibration process for the sensor (e.g., monitoring tool) associated with calibration steps of the process of FIG. 4.

FIG. 6 is a flow chart of an embodiment of a process associated with calibration of the monitoring tool during the setup mode.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.”

In addition, as used herein, the terms “real time,” ”real-time,” or “substantially real time” may be used interchangeably and are intended to described operations (e.g., computing operations) that are performed without any human-perceivable interruption between operations. For example, data relating to the systems described herein may be collected, transmitted, and/or used in control computations in “substantially real time,” such that data readings, data transfers, and/or data processing steps may occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, by a greenhouse gas emission analysis system (i.e., solely by the greenhouse gas emission analysis system, without human intervention).

As discussed in detail below, certain embodiments of a monitoring tool (e.g., gas leak monitoring tool) enable a field setup mode assisted by one or more computing devices to guide a user through various steps of an installation, a communication connection, a proper orientation, and calibration of the monitoring tool. For example, the gas leak monitoring tool may include various sensors, such as a gas leak sensor, a wind sensor, a magnetometer, an accelerometer, and a global positioning system (GPS). The field setup mode is a computer-aided setup procedure, which may be assisted by machine learning and artificial intelligence (AI). The field setup mode may provide feedback (e.g., audio feedback, visual feedback, etc.) to the user during each of the steps, thereby helping to validate or confirm completion of the steps. In certain embodiments, the field setup mode enables the monitoring tool to determine its position in three-dimensional (3D) space using the accelerometer and the GPS. Additionally, the field setup mode enables the monitoring tool to collect magnetometer data from the magnetometer during rotations of the monitoring tool, which data is then used to perform a calibration of the magnetometer. The field setup mode may perform a magnetic North to true North compensation using the location of the monitoring tool available from the GPS as part of the calibration. Once calibrated, the magnetometer of the monitoring tool may function as a compass to perform additional steps of the field setup mode, such as setting a proper orientation of solar panels, the wind sensor, and so forth. Thus, the field setup mode of the monitoring tool may provide computer-aided assistance to the user while setting up the monitoring tool, thereby enabling setup of the monitoring tool that may typically operate in a dormant mode. The field setup mode also may improve the accuracy of calibration data and the proper orientation of solar panels while avoiding human errors and increasing repeatability from one monitoring tool to another. Various aspects of the field setup mode are discussed in further detail below.

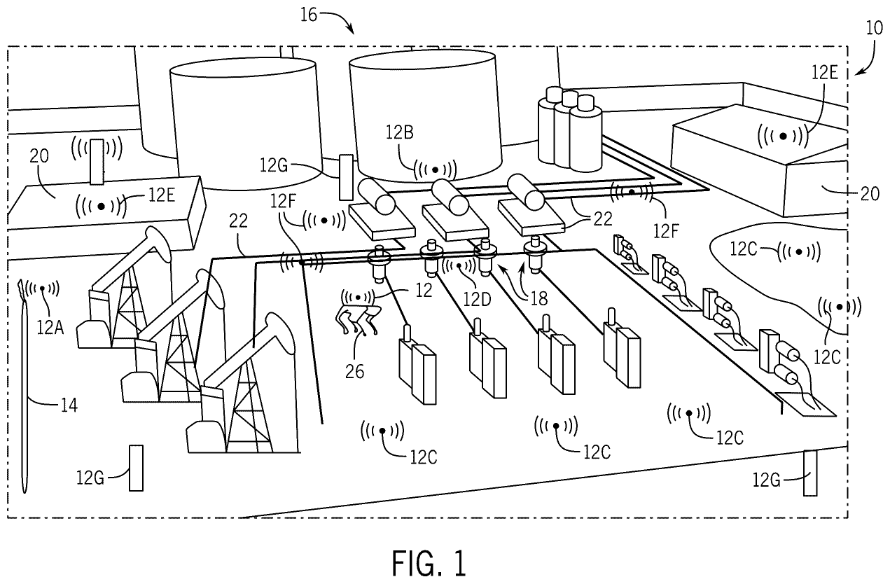

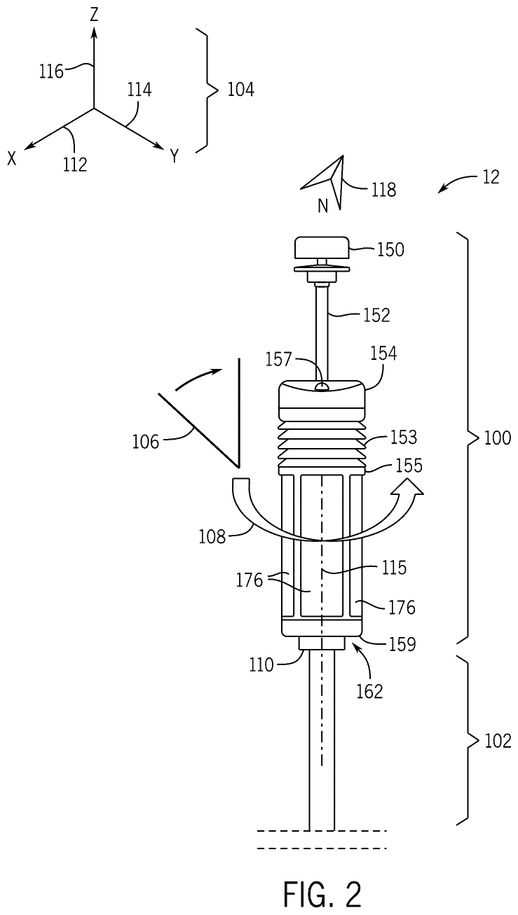

FIG. 1 is a schematic of an embodiment of a facility 10 having a plurality of sensors 12 to monitor fugitive emissions or leaks of greenhouse gases (GHG) at the facility 10. The facility 10 may include any commercial or industrial facility handling fluids (e.g., liquids and gases including GHGs) that may potentially leak into the atmosphere. For example, the facility 10 may include a hydrocarbon (e.g., oil and gas) facility or a chemical refinery, wherein the GHGs may include methane (CH₄), carbon dioxide (CO₂), nitrous oxide (N₂O), and so forth. The fugitive emissions or leaks may originate at various equipment in the facility 10, including but not limited to valves (e.g., flow valves, pressure release safety valves, etc.), tanks, pipes, flanges, fittings, seals, reactors, combustion systems, and various fluid handling equipment. As discussed in detail below, computer-aided systems and methods are provided for installing the sensors 12 in the facility 10, including computer-aided steps of connecting the sensors 12 to a network, orienting the sensors 12 in a proper orientation, calibrating the sensors 12, and finally securing the sensors 12. For example, using local and remote computing systems (e.g., processor-based computers), the computer-aided systems and methods are configured to initiate a field setup mode of the sensor 12 to aid in achieving the desired installation parameters, which include a validation of a connectivity of the sensor 12 to a data processing and control center, a selection of a most optimum communication channel for the sensor 12, a localization of the sensor 12 in a three-dimensional (3D) space to aid in correct installation, a self-calibration of the sensor 12 for use of the sensor 12 as a digital compass that points to either magnetic or true North, and an installation of the sensor 12 for a most efficient use of solar panels relative to the sun. The most efficient use of solar panels relative to the sun may be aligning the solar panels to face a cardinal point of maximum solar exposure. Various aspects of the field setup mode of the sensor 12 are discussed in further detail below with reference to FIGS. 2-6. The following discussion presents the sensors 12 in context of the facility 10 as one possible implementation of the field setup mode of the sensors 12.

In the illustrated embodiment, the sensors 12 may include flare monitors 12A (e.g., positioned on top of a tower/post 14), tank sensors 12B (e.g., positioned near gas tanks 16), gas concentration monitors 12C, compressor health monitors 12D (e.g., positioned near compressors 18), structural monitors 12E (e.g., positioned near process facility structures 20), process monitors 12F (e.g., positioned near various pipelines 22), meteorological sensors 12G, and other suitable sensors capable of providing data related to greenhouse gas emissions (e.g., mobile sensors 12H including one or more of the sensors listed above and positioned on a robotic device 26 (e.g., an unmanned vehicle). The sensors 12 may include fluid leak sensors (e.g., gas leak sensors such as methane leak sensors), gas composition sensors, gas specific sensors (e.g., methane sensors), noise or acoustic sensors, flow rate sensors, pressure sensors, wind sensors or anemometers, temperature sensors, light sensors, flame sensors, or any combination thereof.

In addition, the sensors 12 may include a magnetometer, communication circuitry, local energy storage (e.g., batteries), local energy generation (e.g., solar panels), and a controller (e.g., a processor-based controller). For example, the magnetometer is configured to measure a direction, a strength, and a change in magnetic field at an installation location during the field setup mode of the sensor 12. The communication circuitry may include wired communication circuitry and/or wireless communication circuitry for communicating data with various computing systems (e.g., local computers at the facility 10 and/or remote computers offsite away from the facility 10) during the field setup mode and also during normal operation of the sensor 12. For example, the communication circuitry may include WiFi circuitry (e.g., IEEE 802 protocol), Bluetooth circuitry (e.g., Bluetooth Low Energy (BLE)), wireless broadband circuitry (e.g., long-term evolution (LTE)), long-term evolution machine type communication (LTE-M) circuitry, low-rank adaptation (LoRA) circuitry, or any combination thereof. The controller is configured to execute the field setup mode and the normal operation of the sensor 12 via local operations and/or interaction with one or more computing systems. In certain embodiments, the sensors 12 may be distributed throughout the facility 10 at a plurality of positions using the field setup mode discussed in further detail below.

In some embodiments, certain computing systems may be used to facilitate data collection, processing, and/or transmission. For instance, an edge device may be positioned at or near the facility 10. In some embodiments, the edge device may collect a variety of data (e.g., gas sensor data, image data, location data, time data, and weather data) from different type of data sources that may produce respective data in different data formats. In some embodiments, the edge device may organize (e.g., filter, sort, combine, transform) collected data into a common data pipeline to facilitate data processing and analysis associated with the greenhouse gas emissions that may be used to facilitate gas leak detections.

In some embodiments, one or more digital representations (e.g., computer-implemented simulations) representing a monitored facility (e.g., at the facility 10) in a computational environment may be locally installed in one or more control devices/systems (e.g., gas tank, compressor, and/or pipeline controllers) associated with the facility 10. In some embodiments, the one or more digital representations may be remotely installed in the edge device, such that computing resources (e.g., processing circuitry, memory circuitry) of the one or more control devices/systems may be utilized more efficiently for operation control at the facility 10. Moreover, by performing edge computing at locations near data sources (e.g., the sensors 12 positioned at the facility 10), use of the edge device may reduce an amount of data to be processed in a site (e.g., remote data center, cloud). Additionally, or alternatively, the edge device may transmit data between a local network (e.g., a network covering the facility 10) and an external network 36 (e.g., cloud). The edge device may translate protocols or languages associated with data and used by local systems or devices into protocols or languages used by the cloud where the data may be further processed. It should be noted that, for other applications, the particular system, equipment, and devices may be different or specially adapted to the respective application. For example, in some embodiments, a greenhouse gas emission analysis system (or a portion of the system) may be implemented in the edge device.

Although described primarily herein as pertaining to the facility 10, the field setup mode of the sensors 12 may be used in any applications having sensors needing a setup. For example, the embodiments described herein include systems and methods for identifying placement of fugitive gas emissions sensors from any types of worksites including, but not limited to, emissions of natural gas from well pad equipment or any point in delivery of gas to a point of use. In addition, the embodiments described herein may be applied to other types of gases or fluids (e.g., carbon oxides, nitrogen oxides, ozone, and water vapor) emitted from other types of worksites. In general, the embodiments described herein include placing one or more sensors 12 at a plurality of sensor positions distributed about the facility 10 as illustrated in FIG. 1. Collectively, the sensors 12 may provide continuous and/or periodic measurements of fugitive and vented greenhouse gas emissions with respect to the facility 10. For example, the sensors 12 may acquire sensor measurements for processing by one or more computing devices in real-time, at various prescheduled times or intervals, in response to user requests for sensor measurements, in response to various events at the facility, or any combination thereof.

In certain embodiments, the sensors 12 may include a normal operational mode and a field setup mode. The normal operational mode may include a variety of operational modes, such as a dormant mode, a continuous mode, or a custom mode. The dormant mode may be used to conserve power when not acquiring sensor measurements, and the sensors 12 may periodically wake up from a sleep state to an awakened state to acquire sensor measurements. The continuous mode may be used to continuously acquire sensor measurements rather than periodically waking up from a sleep state. The custom mode may be any suitable operating mode as set by the user, an overall control system for the facility 10, or another computing device.

FIG. 2 is a perspective view of an embodiment of the sensor 12 of FIG. 1, further illustrating the sensor 12 having a monitoring tool 100 (e.g., a sensor portion) coupled to an installation pole 102 (e.g., a sensor mount). The sensor 12 may include all aspects of the sensor 12 as discussed above with reference to FIG. 1. The sensor 12 (e.g., monitoring tool 100) may be described relative to a legend of axes 104, which are used to describe movement of the monitoring tool 100 during a field setup mode. For example, during the field setup mode, the monitoring tool 100 may be configured to move relative to the axes 104 to adjust a tilt 106 and a rotation 108.

The installation pole 102 is coupled to a mount 110 (e.g., pole receptacle, opening, or bore in the monitoring tool 100), which enables the rotation 108 of the monitoring tool 100 during the field setup mode. The mount 110 may be configured to enable rotation of the monitoring tool 100 relative to the installation pole 102 during the field setup mode and secure or fix the position of the monitoring tool 100 after confirming a correct rotational position of the monitoring tool 100. Accordingly, the mount 110 may include an annular bearing to enable the rotation 108 and one or more fasteners (e.g., bolts, screws, clamps, etc.) to fix the rotational position of the monitoring tool 100 to the installation pole 102. The pole 102 may be coupled to the ground, a building, an equipment, or any combination thereof, at an elevated position in the facility 10. In general, the pole 102 may be oriented in a vertical position, although certain embodiments may provide other orientations of the pole 102.

The axes 104 include an x axis 112 (e.g., first horizontal axis), a y axis 114 (e.g., second horizontal axis), and a z axis 116 (e.g., a vertical axis). The x axis 112 and y axis 114 may reside on the same horizontal plane, such as parallel to a ground surface. Conversely, the y axis 114 may be perpendicular to the ground and run approximately along a longitudinal axis 115 of the monitoring tool 100. The monitoring tool 100 is configured to undergo rotation 108 about the z axis 116 during the field setup mode as discussed in further detail below, and the tilt 106 is evaluated as part of the field setup mode.

The tilt 106 is an angular offset of the longitudinal axis 115 of the monitoring tool 100 relative to the z axis 116. The tilt 106 may be associated with an orientation and mounting of the pole 102 on the ground (or other structure) and/or an orientation and mounting of the monitoring tool 100 on the pole 102 at the mount 110. As discussed in further detail below, the tilt 106 may be relevant to the field setup mode (e.g., calibration and orientation data) of the monitoring tool 100. In some embodiments, the monitoring tool 100 may only accept calibration and orientation data during the field setup mode if the mean tilt 106 is less than or equal to X° in any direction relative to the z axis 116 (e.g., mean tilt 106 around an entire circumference of the z axis 116). In some embodiments, the monitoring tool 100 may only accept calibration and orientation data during the field setup mode if the tilt 106 of the monitoring tool 100 is less than or equal to Y° of tilt 106 at any point around the z axis 116. The particular values for X° and Y° may be set by the field setup mode for the monitoring tool 100. These X° and Y° restrictions for acceptable tilt 106 for the monitoring tool 100 may be advantageous by ensuring the quality of the orientation and calibration data to increase the likelihood of accurately determining a true North 118 for the monitoring tool 100 during the field setup mode.

The rotation 108 of the monitoring tool 100 around the longitudinal axis 115 is part of the field setup mode discussed in further detail below. The mount 110 is configured to enable the rotation 108 about an entire circumference (e.g., 360°) of the longitudinal axis 115 and the pole 102. In certain embodiments, the rotation 108 may be manually performed by a technician rotating the monitoring tool 100 while the pole 102 is within the mount 110, automatically by an electric drive in the monitoring tool 100, or any combination thereof. For example, the electric drive may be coupled to the mount 110 to rotate the monitoring tool 100 about the pole 102. The rotation 108 of the monitoring tool 100 may be performed to adjust an orientation of the monitoring tool 100, such that the monitoring tool 100 faces true North when the position of the monitoring tool 100 is finalized in the field setup mode. The connection between the mount 110 of the monitoring tool 100 and the pole 102 may have a loose connection, a snug connection, or a variable tightness connection to enable the rotation 108. Once in the proper orientation, the monitoring tool 100 may be securely mounted to the pole 102 at the mount 110, such as by tightening the connection at the mount 110. The field setup mode is discussed in further detail below.

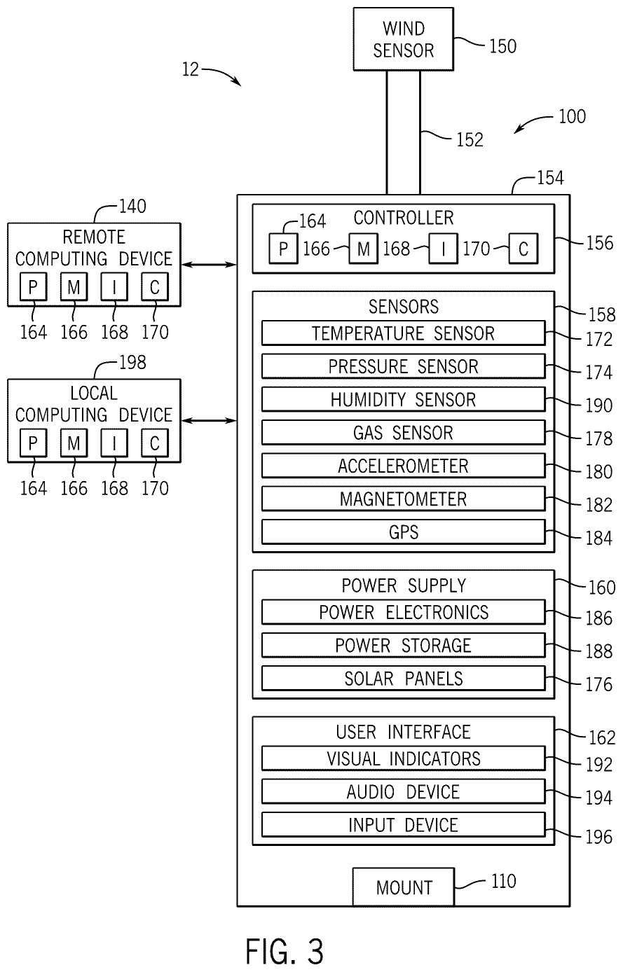

In the illustrated embodiment, the monitoring tool 100 includes a wind sensor 150 (e.g., anemometer) coupled to a body 154 (e.g., housing or enclosure) via a neck 152 (e.g., shaft, arm, or extension). The wind sensor 150 is configured to sense a wind direction and a wind speed of wind around the monitoring tool 100. The wind direction and the wind speed may be used by the monitoring tool 100 to help locate a source of sensed parameters, such as a sensed gas leak. As discussed in further detail below with reference to FIG. 3, the monitoring tool 100 includes a controller 156, a sensing system 158 having a plurality of sensors, a power supply 160, and a user interface 162 coupled to and/or partially housed within the body 154. For example, the sensors may be disposed within the body 154 and in fluid communication with a surrounding environment via an annular vent section 153 (e.g., a plurality of angled annular louvers) of the body 154. By further example, the power supply 160 may be coupled to an annular section 155 (e.g., lower annular section) of the body 154, wherein the power supply 160 includes a plurality of solar panels 176 coupled to the annular section 155. The power supply 160 also may be coupled to a solar sensor 157 on the body 154. In some embodiments, the user interface 162 may be coupled to the body 154 at one or more locations, such as a lower annular section 159 of the body 154. For example, the user interface 162 may include visual indicators 192 (e.g., LEDs, display screen, etc.), an audio device 194 (e.g., a speaker), and one or more input devices 196 (e.g., power button or switch, a setup button, selection buttons, etc.) as discussed in further detail below.

FIG. 3 is a block diagram of an embodiment of the sensor 12 of FIGS. 1 and 2, further illustrating components within the body 154 of the monitoring tool 100. The sensor 12 and the monitoring tool 100 have all aspects as described in detail above with respect to FIGS. 1 and 2. In the illustrated embodiment, the wind sensor 150 is coupled to the body 154 via the neck 152, wherein the wind sensor 150 is configured to monitor wind conditions (e.g., wind direction and wind speed) around the monitoring tool 100. The monitoring tool 100 uses the wind conditions in combination with other sensor feedback (e.g., gas leak feedback) to help identify a source of a gas leak. The monitoring tool 100 further includes the controller 156, the sensing system 158 having a plurality of sensors, the power supply 160, the user interface 162, and the mount 110, each of which is described in further detail below. The monitoring tool 100 is also configured to communicate with one or more computing devices, such as a local computing device 198 and a remote computing device 140 during a field setup mode and also during a normal operational mode. The various components of the monitoring tool 100 will be discussed before discussing the field setup mode.

The controller 156 is configured to control operation of the monitoring tool 100, including all or part of the field setup mode and the normal operational mode. The controller 156 includes one or more processors 164, memory 166, instructions 168, and communication circuitry 170. The communication circuitry 170 is configured to enable wired or wireless communication between the controller 156 one or more computing devices, such as the local computing device 198 and the remote computing device 140. For example, the communication circuitry may include WiFi circuitry (e.g., IEEE 802 protocol), Bluetooth circuitry (e.g., Bluetooth Low Energy (BLE)), wireless broadband circuitry (e.g., long-term evolution (LTE)), long-term evolution machine type communication (LTE-M) circuitry, low-rank adaptation (LoRA) circuitry, or any combination thereof. The processor(s) 164 may be any suitable type of computer processor or microprocessor capable of executing computer-executable code. Moreover, the processor(s) 164 may include multiple microprocessors, one or more “general-purpose” microprocessors, one or more special-purpose microprocessors, and/or one or more application specific integrated circuits (ASICS), or some combination thereof. For example, the processor(s) 120 may include one or more than one reduced instruction set (RISC) or complex instruction set (CISC) processors. The memory 166 may also be used to store instructions 168 executed by the processor(s) 164, setup data of the field setup mode, sensor data acquired by the sensing system 158, and other software applications. The memory 166 may represent non-transitory computer-readable media (e.g., any suitable form of memory 166 or storage) that may store the processor-executable code used by the processor(s) 164 to perform various techniques described herein. As illustrated, the monitoring tool 100 includes one or more controllers 156 that communicate with and/or control data acquisition from the sensing system 158.

In certain embodiments, the sensing system 158 includes a plurality of sensors, transducers, and/or instruments configured to measure parameters useful for the field setup mode and the normal operational mode of the monitoring tool 100. For example, the sensing system 158 may include a temperature sensor 172 (e.g., thermometer), a pressure sensor 174, a humidity sensor 190, a gas sensor 178, an accelerometer 180, a magnetometer 182, and a satellite-based navigation system (e.g., a global positioning system (GPS) 184). The gas sensor 178 may be configured to monitor one or more gas compositions associated with gas leaks. For example, the gas sensor 178 may include a variety of GHG sensors, such as a methane (CH₄) sensor, a carbon dioxide (CO₂) sensor, a nitrous oxide (N₂O) sensor, and so forth. It should be noted that the sensors in the sensing system 158 may include any configuration of the above listed sensors. Further, it should be noted that other sensors not listed may be included in the sensing system 158 in addition to, or in place of other sensors. The sensing system 158 and the foregoing sensors enable a computer-aided setup (e.g., field setup mode) and a computer-aided operation (e.g., normal operation mode), including a proper orientation, calibration, and mounting of the monitoring tool 100 during the field setup mode. For example, the accelerometer 180, the magnetometer 182, and the GPS 184 may enable the monitoring tool 100, the local computing device 198, and/or the remote computing device 140 to perform the calibration and guide the proper placement of the monitoring tool 100 during the field setup mode. By further example, the temperature sensor 172, the pressure sensor 174, the humidity sensor 190, the gas sensor 178, and the GPS 184 may enable the monitoring tool 100, the local computing device 198, and/or the remote computing device 140 to perform monitoring of the facility 10, identification of gas leaks, and identification of source locations and/or equipment associated with the gas leaks.

The monitoring tool 100 also includes the power supply 160 configured to provide power to the controller 156, the sensing system 158, and the user interface 162. The power supply 160 includes power electronics 186, power storage 188, and solar panels 176. The power electronics 186 may include semiconductor devices, AC/DC converters, circuitry, wiring, and the like. The power storage 188 may include batteries, capacitors, or any combination thereof. The solar panels 176 may be arranged about an exterior of the body 154, and configured to generate electricity for storage in the power storage 188 and use to power the monitoring tool 100. In certain embodiments, the field setup mode may be configured to provide computer-aided assistance to ensure optimal placement of the solar panels 176.

The monitoring tool 100 also includes the user interface 162 to facilitate the field setup mode and normal operational mode. The user interface 162 may include one or more visual indicators 192, one or more audio devices 194, and one or more input devices 196. The one or more visual indicators 192 may be one or more lights (e.g., LEDs), an electronic display screen, or any combination thereof. For example, the lights (e.g., LEDs) may be configured to display different colors, different steady or pulsing flashes of light, or any combination thereof, to indicate various statuses during the field setup mode. The one or more audio devices 194 may include a speaker or any other device capable of outputting sound. The one or more input devices 196 may include a touchscreen, a button or switch, a keypad, or any combination thereof. For example, the input devices 196 may include a power button or switch, a setup button or switch, a reset button or switch, and user selection inputs. The input devices 196 also may include a wired communication port to enable connection with the local computing device 198.

The monitoring tool 100 also includes the mount 110 configured to couple to the pole 102. As discussed above, the mount 110 may include an annular structure (e.g., annular receptacle) configured to couple to the pole 102, enabling rotation 108 when needed during the field setup mode, and fixing the position of the monitoring tool 100 at an end of the field setup mode. In certain embodiments, the mount 110 may include an annular bearing to facilitate the rotation 108, an electric device configured to drive the rotation 108, and/or one or more fasteners (e.g., bolts, screws, clamps, etc.) configured to secure the position of the monitoring tool 100 to the pole 102. For example, the mount 110 may enable free rotation of the monitoring tool 100 about an entire circumference (e.g., 360°) around the pole 102, such that the field setup mode can determine a correct orientation of the monitoring tool 100.

The monitoring tool 100 may also connect to one or more local computing devices 198, one or more remote computing devices 140, or both. The local computing devices 198 and remote computing devices 140 may include processors 164, memory 166, instructions 168, and communication circuitry 170, similar to those described above with reference to the controller 156. The local and remote computing devices 198 and 140 may include portable computers (e.g., laptops, tablets, smart phones, etc.), servers, cloud-based computing devices, edge devices, or any combination thereof. The local and remote computing devices 198 and 140 may provide additional computing resources to facilitate the field setup mode and/or the normal operational mode of the monitoring tool 100 as discussed in further detail below. For example, the local and remote computing devices 198 and 140 may receive initial data from the monitoring tool 100 during the field setup mode, identify true North, generate calibration data, and return calibration data to the monitoring tool 100 during the field setup mode.

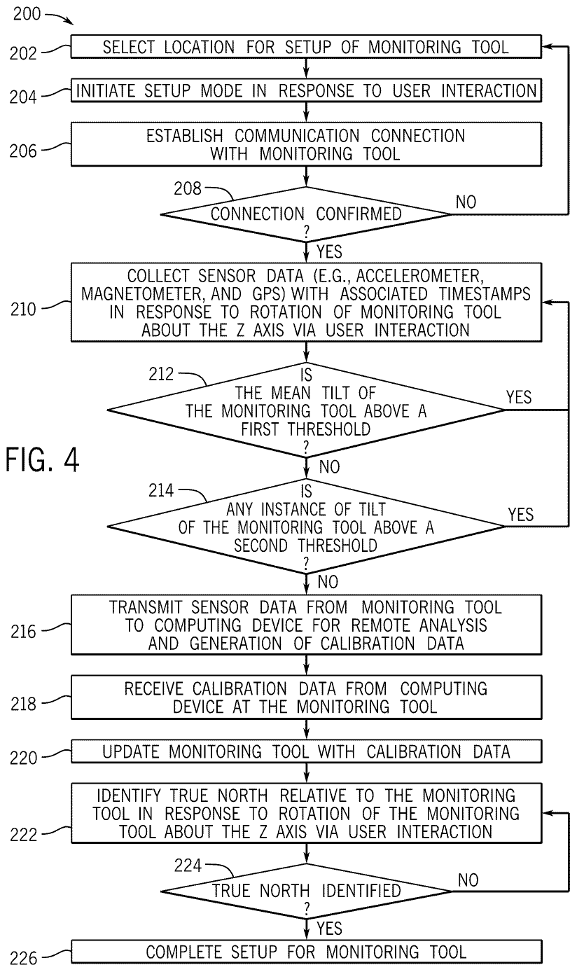

FIG. 4 is a flow chart of an embodiment of a process 200 of installing the sensor 12 (e.g., monitoring tool 100) of FIGS. 1-3 according to a field setup mode. The process 200 may be performed on the monitoring tool 100, the local computing device 198, the remote computing device 140, or any combination thereof. At block 202, the process 200 may include selecting a location for setup of the monitoring tool 100. In some embodiments, a user selects the location based on their personal knowledge of factors such as the company's needs, nearby equipment, likelihood of leak locations, the landscape of the area, and the like. In some embodiments, a computer-aided system (e.g., artificial intelligence) may select the location based on previous leak locations, predicted leak locations, likelihood of leak locations, the landscape of the area, computer models of the facility 10, and the like. In still other embodiments, the computer-aided system (e.g., artificial intelligence) may suggest a plurality of potential locations for the setup, and a user may select one of the potential locations for the setup based on the user's experience, knowledge, or the like. This may be advantageous by simplifying the process for the user while utilizing the user's personal knowledge.

The process 200 then initiates a setup mode (e.g., field setup mode) in response to user interaction at block 204. User interaction may include pressing a setup button on the user interface 162, plugging in an external device, using a keypad, interacting with an external computing device (e.g., 184, 186), or the like. A visual indicator 192, audio device 194, or both, may indicate that the user interaction initiated the setup mode. In certain embodiments, the visual indicator 192 on the monitoring tool 100 may provide a visual signal when the setup mode begins. For example, when the user presses a setup button on the monitoring tool 100, the visual indicator 192 (e.g., LED) may begin flashing in a certain color (e.g., green) to indicate that the monitoring tool 100 has entered the setup mode. This may be advantageous when a user initiates setup mode using a button by providing a confirmation to users which otherwise may not exist. The setup mode may step through a plurality of sub-modes, such as a connection mode (e.g., network connection mode), a self-calibration mode, and a positioning mode (e.g., orientation relative to true North 118, orientation of solar panels 176, securement of monitoring tool, etc.). The sub-modes also may include additional steps or sub-modes, such as an operational setting mode configured to enable user input regarding various operational settings for a normal operating mode of the monitoring tool 100.

At block 206 of the setup mode, the process 200 may execute the connection mode and attempt to establish a communication connection with the monitoring tool 100, such as a network connection between the monitoring tool 100 and one or more computing systems. The one or more computing systems may include the local computing device 198 and/or the remote computing device 140, such as an edge device, a cloud-computing device, or a combination thereof. This communication connection may provide a path for the monitoring tool 100 to send and receive data, calibrate the monitoring tool 100, and locate true North 118. The communication connection may include a wireless communication connection as discussed in detail above.

At block 208 of the setup mode, the process 200 may determine if the connection is confirmed between the monitoring tool 100 and the one or more computing systems. If the connection is not confirmed at block 208, then the monitoring tool 100 may indicate that the connection could not be confirmed via the user interface 162 (e.g., visual indicators 192, audio device 194) and/or the local computing device 198. In some embodiments, the visual indicator 192 (e.g., LED) may output light in a color (e.g., red), a solid or flashing sequence, or any combination thereof, to notify the user of a failure to connect at block 208. For example, if the setup mode normally outputs a flashing green light, then the failed connection may outlet a solid red light on the visual indicator 192. In some embodiments, the monitoring tool 100 may send a troubleshooting notification or alert to a user device (e.g., local computing device 198) communicating with the monitoring tool 100. If the monitoring tool 100 cannot confirm the connection, then the process 200 may return to block 202 and prompt the user to select a different location for the setup of the monitoring tool 100.

If the connection is confirmed at block 208, the monitoring tool 100 may indicate that the connection is confirmed via the user interface 162. In some embodiments, the confirmed connection may be shown on the same or a different visual indicator 192. For example, the visual indicator 192 (e.g., LED) on the monitoring tool 100 may change from the flashing green light representing the setup mode to a solid green light representing an active connection stage. By further example, the user interface 162 may include a first visual indicator 192 (e.g., LED) that represents the setup mode (e.g., flashing green light) and a second visual indicator 192 (e.g., LED) that represents a connection state (e.g., solid red is no connection, solid green is an active connection). In some embodiments, the monitoring tool 100 may send a notification or alert to a user device (e.g., local computing device 198) communicating with the monitoring tool 100 to inform the user that connection was successful. In certain embodiments, feedback regarding the communication (e.g., confirmed or failed) may be output on the user interface 162, a mobile application on a mobile device, and/or a web page on a computing device.

At block 210 of the setup mode, after confirming the communication connection at block 208, the process 200 may proceed to execute the self-calibration mode and collect sensor data with associated timestamps in response to rotating the monitoring tool 100 around the z axis 116 (e.g., longitudinal axis 115). The self-calibration mode may continue through at least blocks 210, 212, 214, 216, 218, and 220 of the process 200. The rotation 108 of the monitoring tool 100 may be achieved manually by a user rotating the monitoring tool 100, automatically by an electric drive of the monitoring tool 100, automatically by an electric drive coupled to the pole 102, or any combination thereof. The rotation 108 may be at a desired rotational speed or within a desired rate of rotation. If the speed of rotation 108 is too fast or too slow, then the process 200 may provide an alert or notification (e.g., audio or visual notice) of an incorrect speed of rotation 108. The sensor data may include accelerometer data from the accelerometer 180, magnetometer data from the magnetometer 182, and global positioning system (GPS) data from the GPS 184. However, the collected sensor data may include data from other sensors, such as those described in detail above in FIG. 3. The setup mode may use the GPS data and the accelerometer data to identify a location (e.g., 3D coordinates) of the monitoring tool 100. The location of the monitoring tool 100 is used for calibration of the monitoring tool 100 (e.g., magnetometer) as discussed in further detail below.

At block 212 of the setup mode, the process 200 may determine if a mean tilt 106 of the monitoring tool 100 is above a first threshold. The mean tilt may be the mean value of the tilt 106 over a range of the rotation 108 of the monitoring tool 100 around the z axis 116 of the pole 102 (e.g., longitudinal axis 115), as performed during block 210 of the process 200. The setup mode may provide the first threshold as a first calibration criteria to ensure that the tilt 106 is not excessive and unsuitable to complete the calibration of the monitoring tool 100. In some embodiments, the first threshold may be a tilt threshold of about 5 percent, or a tilt threshold of 2, 3, 4, 5, 6, or 7 percent. In some embodiments, the user, the monitoring tool 100, the local computing device 198, and/or the remote computing device 140 may set the first threshold for the tilt. The mean tilt accounts for variations in the tilt 106 during the rotation 108, and thus enables a first check of the setup mode to ensure the tilt is not excessive. If the mean tilt is less than or equal to the first threshold, then the process 200 passes this first calibration criteria and moves on to a second calibration criteria in block 214. However, if the mean tilt is greater than the first threshold, then the process 200 fails this first calibration criteria and returns to block 210 to collect more sensor data (possibly with adjustments to the pole 102 and/or the mounting of the monitoring tool 100 to the pole 102).

At block 214 of the setup mode, the process 200 may determine if any instance of tilt 106 of the monitoring tool 100 is above a second threshold. Any instance of tilt 106 may be any single measured tilt of the monitoring tool 100 when the monitoring tool 100 is rotating about the z axis 116 during block 210 of the process 200. The setup mode may provide the second threshold as a second calibration criteria to ensure that the tilt 106 is not excessive and unsuitable to complete the calibration of the monitoring tool 100. In some embodiments, the second threshold may be a tilt threshold of about 5 percent, or a tilt threshold of 2, 3, 4, 5, 6, or 7 percent. In some embodiments, the user, the monitoring tool 100, the local computing device 198, and/or the remote computing device 140 may set the second threshold for the tilt. Additionally, in some embodiments, the first and second thresholds for the tilt 106 may be the same or different from one another. If the tilt is less than or equal to the second threshold, then the process 200 passes this second calibration criteria and continues the setup mode at block 216. However, if the tilt is greater than the second threshold, then the process 200 fails this second calibration criteria and returns to block 210 to collect more sensor data (possibly with adjustments to the pole 102 and/or the mounting of the monitoring tool 100 to the pole 102).

At block 216 of the setup mode, the monitoring tool 100 may transmit sensor data from the monitoring tool 100 to the computing device for remote analysis and generation of the calibration data (e.g., calibration coefficients). In some embodiments, the computing device may be a device plugged directly into the monitoring tool 100. In other embodiments, the computing device (e.g., local computing device 198 and/or remote computing device 140) may be connected to the monitoring tool 100 through a network (e.g., wired or wireless network). For example, the computing device may include the remote computing device 140, such as an edge device and/or a cloud-based computing device. Thus, any processor-intensive analysis of the sensor data may be handled by the computing device, rather than directly on the controller 156 of the monitoring tool 100. This may be advantageous to reduce the cost and complexity of the monitoring tool 100 (e.g., lower cost processor 164 on the controller 156), while obtaining greater processing power when needed during the field setup mode and/or during a normal operational mode. At block 216 of the field setup mode, the computing device uses the previously collected magnetometer data from the magnetometer during rotations of the monitoring tool (block 210) to perform a calibration of the magnetometer. The calibration of the magnetometer includes a hard/soft iron magnetometer calibration, which is an iron interference compensation for the hard and soft-iron interferences caused by electric currents on the electronic board as well as the nearby metallic objects that may disturb the readings of the magnetometer. For example, the hard/soft iron magnetometer calibration may include a calculation of correction factors, including offsets for normalizing the gains on the x axis 112 and the y axis 114. These correction factors are subsequently applied to raw X and Y magnetic field data of the magnetometer, as discussed in further detail below. Additionally, the computing device may perform a magnetic North to true North compensation using the location of the monitoring tool available from the GPS and the accelerometer as part of the calibration. The magnetic North to true North compensation includes offsetting for the declination angle (e.g., magnetic declination compensation), which varies based on the geographic location (e.g., GPS location) and the date. The date may be available from either the GPS or the network (e.g., Cell/LoRA network) connected to the monitoring tool 100 when collecting sensor data in block 210.

At block 218 of the setup mode, the monitoring tool 100 may receive the calibration data from the computing device. The process 200 may transfer the calibration data over the network from the computing device to the monitoring tool 100. At block 220 of the setup mode, the monitoring tool 100 may update with calibration data. For example, the controller 156 of the monitoring tool 100 may receive, store, and process the calibration data generated remotely on the computing device, and update the magnetometer. This update may provide the monitoring tool 100 with information necessary to accurately locate truth North 118 based on the location of the monitoring tool 100 on the planet, as the calibration data may account for nearby magnetic disturbances from electrical fields, and the magnetic field at the monitoring tool's 100 location. In certain embodiments, the calibration data enables corrections of raw data from the magnetometer to perform the task of a digital compass.

At block 222 of the setup mode, the monitoring tool 100 may execute a positioning mode and attempt to identify true North relative to the monitoring tool 100 in response to rotation of the monitoring tool 100 about the z axis 116. Using the magnetometer as a digital compass, the monitoring tool 100 may use trigonometry formulas to calculate the angle of the monitoring tool 100 relative to true North 118. As noted above, the rotation of the monitoring tool 100 may be achieved manually by user interaction (e.g., manually turning the monitoring tool 100), an electric drive in the monitoring tool 100 that drives rotation of the monitoring tool 100 relative to the pole 102, and/or an electric drive coupled to the pole 102 that drives rotation of the pole 102 and the monitoring tool 100. The setup mode may provide feedback regarding true North (e.g., achieved or not achieved) via the user interface 162, a mobile application on a mobile device, and/or a web page on a computing device. For example, the monitoring tool 100 may indicate when true North has been located through the visual indicators 192, the audio device 194, or any feedback provided on the user interface 162. In certain embodiments, a light (e.g., LED) on the monitoring tool 100 may flash at an increasing speed as the monitoring tool 100 moves closer to the location of true North 118, and then turn a solid color when the monitoring tool 100 reaches the position of true North 118. In certain embodiment, the monitoring tool 100 may beep at an increasing speed as the monitoring tool 100 moves closer to the location of true North 118, and then output an uninterrupted sound when the monitoring tool 100 reaches the position of true North 118. However, any suitable visual or audible feedback may be used by the setup mode to indicate the true North 118 position of the monitoring tool 100. In certain embodiments, an electronic display may output a visual representation of a digital compass showing cardinal directions for navigation (e.g., North, South, East, and West), and illustrating a changing position relative to true North 118 during the rotation of the monitoring tool 100. Thus, the digital compass displayed on the electronic display may enable precision positioning of the monitoring tool 100 relative to true North 118.

At block 224 of the setup mode, the process 200 may determine if the monitoring tool 100 has identified and is correctly positioned relative to true North 118. In one embodiment, the monitoring tool 100 may be precisely positioned at true North 118. However, the user may not need to be precise in locating true North 118. In one embodiment, the monitoring tool 100 may be within 5°, 4°, 3°, 2°, or 1° of true North 118 in either direction about the z axis 116. For example, the monitoring tool 100 may accept 3° offset from true North 118. This may be advantageous by creating room for user error in installing the monitoring tool 100, while still remaining within a clearly defined and acceptable margin of error of the purpose. If the monitoring tool 100 has not identified true North 118, the process 200 may return to block 222 and the monitoring tool 100 may identify true North 118 relative to the monitoring tool 100 in response to rotation of the monitoring tool 100 about the z axis 116 through user interaction again.

If the monitoring tool 100 has identified true North 118, the process 200 may progress to block 226 and complete setup for the monitoring tool 100. The complete setup may include securing the position of the monitoring tool 100 relative to the pole 102 and completing any additional setup steps of the setup mode. The additional setup steps may include executing an operational setting mode to configure various operational parameters or settings of the monitoring tool 100, such as frequency of sensor measurements, types of sensor measurements at each time interval, thresholds for any alerts or alarms in response to the sensor measurements, and so forth.

After completing the setup at block 226, the monitoring tool 100 may execute a normal operating mode to monitor various aspects of the facility 10 using the plurality of sensors of the sensing system 158 and the wind sensor 150. For example, the monitoring tool 100 may monitor for gas leaks via the gas sensor 178 and wind speed and direction via the wind sensor 150, estimate a source location of any gas leaks, estimate a severity of any gas leaks based on concentration levels of the gas, and output alerts or alarms via the local computing device 198 and/or the remote computing device 140. Additionally, the monitoring tool 100 may trigger one or more control actions to control equipment in the facility 10, such as by adjusting valves (e.g., opening or closing valves, opening release valves, etc.), adjusting a speed of a compressor or pump, adjusting a flow of input materials into a reactor or combustor, shutting down certain equipment and/or portions of the facility 10, or any combination thereof. The monitoring tool 100 also may trigger one or more service actions, such as automatically scheduling inspections and/or service by a service technician, automatically scheduling additional measurements by the monitoring tool 100 and/or separate monitoring tools 100 in the facility 10, or any combination thereof.

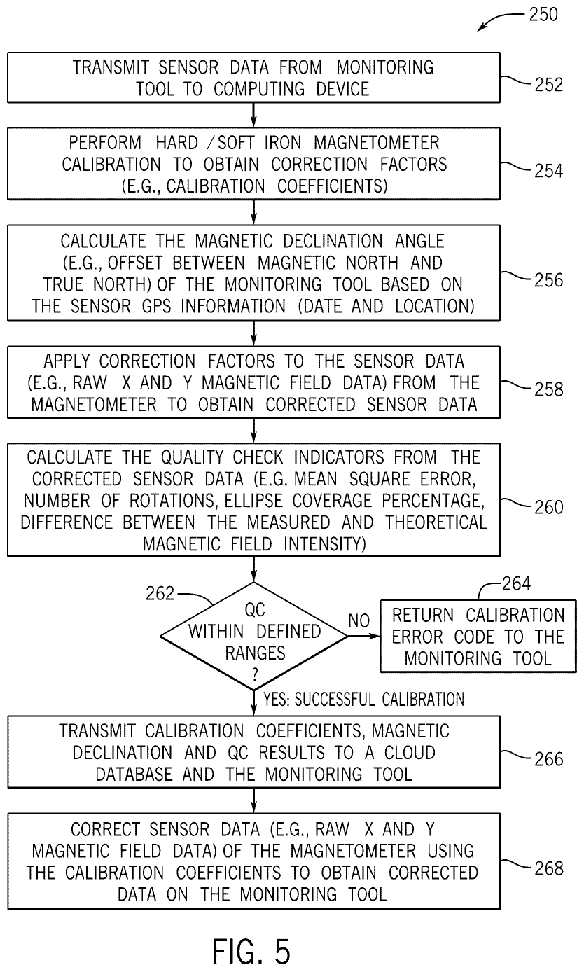

FIG. 5 is a flow chart of an embodiment of a calibration process 250 associated with blocks 216 and 218 of the process 200 of FIG. 4. The process 250 may be performed on the monitoring tool 100, the local computing device 198, the remote computing device 140, or any combination thereof. The calibration process 250 relates to calibration of the monitoring tool 100 during the setup mode initiated in the process 200 of FIG. 4. In block 252 of the setup mode, the calibration process 250 transmits sensor data (e.g., accelerometer, magnetometer, and GPS data as described in block 210) from the monitoring tool 100 to the computing device (e.g., local computing device 198 and/or remote computing device 140).

In block 254 of the setup mode, the computing device may perform a hard/soft iron magnetometer calibration to obtain correction factors (e.g., calibration coefficients). In block 254, the computing device utilizes data retrieved from the sensors regarding nearby electric or magnetic fields which may be interrupting Earth's magnetic field. These correction factors may account for any interrupting magnetic or electric fields.

At block 256 of the setup mode, the computing device may calculate the magnetic declination angle (e.g., offset between magnetic North and true North 118) of the monitoring tool 100 based on the sensor GPS information (e.g., date and location). The date and location may affect the magnetic field of Earth at that location, as the magnetic field may change depending on the time and location on Earth. Once the computing device calculates the magnetic declination angle, at block 258 the computing device may apply the correction factors calculated in block 254 to the sensor data (e.g., raw x and y magnetic field data) from the magnetometer to obtain corrected sensor data.

At block 260 of the setup mode, the computing device may calculate the quality check indicators from the corrected sensor data. The quality check (QC) indicators may include the mean square error, the number of rotations, the ellipse coverage percentage, and the difference between the measured and theoretical magnetic field intensity. For each quality check indicator, at block 262 the computing device may query whether each QC is within its respective defined range. If one or more of the QC indicators is not within a defined range, the computing device may return a calibration error code to the monitoring tool 100 at block 264. In some embodiments, the calibration error code may require the user to return to block 210 to reacquire sensor data to use in a new calibration. In other embodiments, the error code may inform the user that there is an error in the computing device which may prevent accurate QC calculation. If all of the QC indicators are within the defined range, the computing device may progress to block 266.

At block 266 of the setup mode, the computing device may transmit the correction factors (e.g., calibration coefficients), magnetic declination angle, and QC results to a cloud database and the monitoring tool 100. Once transmitted, at block 268, the monitoring tool 100 may correct the sensor data (e.g., raw x and y magnetic field data) of the magnetometer using the correction factors (e.g., calibration coefficients) to obtain corrected data on the monitoring tool 100.

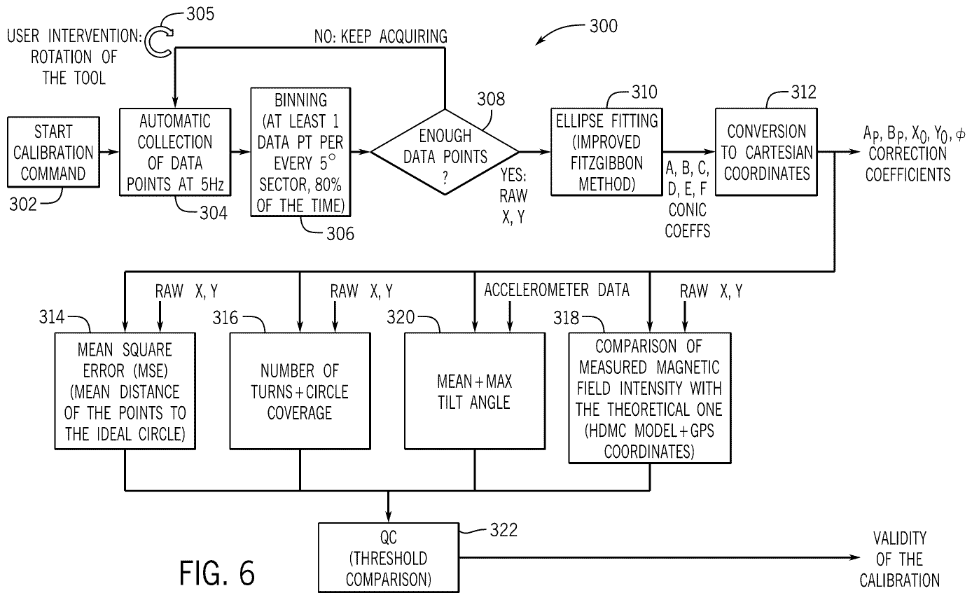

FIG. 6 is a flow chart of an embodiment of a process 300 associated with calibration of the monitoring tool 100 during the setup mode. Various aspects of the process 300 overlap with the process 200 of FIG. 4 and the process 250 of FIG. 5. All aspects of the monitoring tool 100 are the same as described in detail above with reference to FIGS. 1-3. The process 300 may be performed on the monitoring tool 100, the local computing device 198, the remote computing device 140, or any combination thereof.

During the setup mode, the process 300 initiates a calibration command at block 302, wherein the process 300 steps through various aspects of calibration of the monitoring tool 100. For example, the process 300 may perform an automatic collection of data points via sensors of the monitoring tool 100 at block 304 during a rotation 305 of the monitoring tool 100. In certain embodiments, the monitoring tool 100 automatically acquires sensor data (e.g., accelerometer and magnetometer data) along with timestamps during the rotation 305 of the monitoring tool 100. The automatic collection of data points may occur at a sampling frequency of 3, 4, 5, 6, 7 or 8 hertz. In certain embodiments, the frequency may be set at a variety of frequencies; however, the process 300 may operate at a minimum frequency of at least 3 hertz.

At block 306 of the setup mode, the process 300 may begin a binning process of the data points collected at block 304. Specifically, the process 300 may roughly estimate the location of the current magnetometer data point on a circle (e.g., based on the monitoring tool's 100 rotation about the z axis 116). The process 300 may request at least one data point in every 5° sector of the circle in at least 80% of the sectors to properly describe the circle. This may be advantageous for ensuring good coverage of data around the circle.

At block 308 of the setup mode, the process 300 may determine if the binning process at block 306 acquired enough data points. If the process 300 did not acquire enough data points, the process 300 may revert back to block 304 and the process 300 may continue to acquire data points at the same sample frequency, or a different sample frequency. If the process 300 determines it collected enough data points, the process 300 may progress to block 310.

At block 310 of the setup mode, the process 300 may engage in ellipse fitting using an improved Fitzgibbon method. The improved Fitzgibbon method may be used to obtain the best fit conic coefficients for an ellipse. The Fitzgibbon method may use the formula F_{(x, y)}=ax²+bxy+cy²+dx+ey+f=0. Once the Fitzgibbon method is complete, the process 300 may have a, b, c, d, e, and f conic coefficients.

At block 312 of the setup mode, the process 300 may convert the conic coefficients to cartesian coordinates. This may be advantageous by translating the coefficients into a format more compatible with the goals and needs of the monitoring tool 100. Once translated, the correction coefficients may include the length of the semimajor and semi-minor axis as aₚ, bₚ, the locus of the ellipse x₀, y₀, and the phi angle between the x-axis and the semi-major axis φ. From block 312, the process 300 may send the raw data acquired at block 304 and binned in block 306 to block 314, block 316, and block 318. The process 300 may also send accelerometer data acquired at block 304 to block 320. The combination of results from block 314, block 316, block 318, and block 320 create a QC (e.g., threshold comparison) at block 322. The QC at block 322 may determine the validity of the calibration. An invalid calibration may require the user to restart the data acquisition process to ensure the calibration is valid and may thus lead to an accurate location of true North 118.

At block 314 of the setup mode, the process 300 may calculate a mean square error (MSE). The MSE is the mean distance of the corrected data points to the ideal circle. This metric may be advantageous by identifying noisy data, excessive tilt, presence of a strong magnetic field nearby, and the like, that would indicate non optimal conditions for the location of the monitoring tool 100. In some embodiments, comparing the MSE to the QC threshold may render a recommendation that the user relocate the monitoring tool 100 if the MSE is above a threshold MSE. Relocating the monitoring tool 100 may eliminate the presence of the strong nearby magnetic field. In some embodiments, comparing the MSE to the QC threshold may render a recommendation that the user interact with the monitoring tool 100 again to recollect data, which may eliminate excessive tilt or noisy data issues.

At block 316 of the setup mode, the process 300 may verify that user interaction has yielded a sufficient number of rotations of the monitoring tool 100 and sufficient coverage of the circle. In some embodiments, the process 300 may require 1.5 or more rotations to ensure sufficient data points for the process 300 to use in its calibration. If the number of turns and circle coverage does not meet the threshold required by the QC, the process 300 may render a recommendation that the user interact with the monitoring tool 100 again to recollect data and may specify that the monitoring tool 100 undergo more rotations to collect adequate data.

At block 320 of the setup mode, the process 300 may verify that the mean and maximum tilt angle does not exceed a threshold amount. This verification step is described above in block 212 and block 214 of FIG. 4. In some embodiments, the verification step at block 320 is the same as the step in block 212 and block 214. In other embodiments, the verification step at block 320 is a repeat of the step at block 212 and block 214 to double check the mean and maximum tilt. This may be advantageous by ensuring the tilt angle does not exceed a threshold angle for any given calibration data set.

At block 318 of the setup mode, the process 300 compares the measured magnetic field intensity with the theoretical magnetic field intensity. The process 300 uses geomagnetic models to complete this comparison. Further, the process 300 computes the theoretical value used for comparison similarly to how the system computes the declination angle, using GPS and date/time information. If the process 300 determines the difference between the theoretical and actual magnetic field intensity surpasses a threshold amount, the process 300 may may render a recommendation that the user interact with the monitoring tool 100 again to recollect data.

If block 314, block 316, block 318, and block 320 are all below their respective thresholds, the process 300 may validate the calibration and send the calibration data from the computing device to the monitoring tool 100 at block 218. Other aspects of the setup mode are substantially the same as described above with reference to FIGS. 4 and 5.

Technical effects of the disclosed embodiments enable a field setup mode for a monitoring tool 100, wherein one or more computing devices (e.g., 184, 186) aid in the setup of the monitoring tool 100 along with user interaction with the monitoring tool 100. The setup mode is particularly advantageous for monitoring tools typically operating in a dormant state without any readily available way to interact with the monitoring tool, and thus the field setup mode adds a field service functionality aided by processing resources of separate computing devices. In certain embodiments, the setup mode guides a user to initiate and validate a communication connection between the monitoring tool 100 and a network, obtain a position of the monitoring tool 100 in 3D space, obtain sensor data (e.g., magnetometer, accelerometer, and GPS data) while rotating the monitoring tool 100, send the sensor data to the computing device for generation of calibration data using processing resources of the computing device, and calibrate the monitoring tool 100 (e.g., calibrate the magnetometer) using the calibration data generated by the computing device. Once calibrated, the magnetometer may function as a digital compass to guide the monitoring tool 100 to a true North 118 position. Thus, the field setup mode adds functionality to the monitoring tool 100 beyond the dormant mode, such that the field setup mode more efficiently and accurately sets up the monitoring tool 100 at the facility 10.

The subject matter described in detail above may be defined by one or more clauses, as set forth below.

A system includes a monitoring tool having one or more sensors, a power supply, and a controller coupled to the one or more sensors and the power supply. The controller has a processor, a memory, and instructions stored on the memory and executable by the processor to operate in a setup mode and a normal operational mode. The setup mode is configured to collect sensor data during a first rotational movement of the monitoring tool about a central axis of a mount, obtain calibration data based on the sensor data, calibrate the monitoring tool based on the calibration data, and identify a true North orientation of the monitoring tool during a second rotational movement of the monitoring tool about the central axis of the mount.

The system of the preceding clause, wherein the plurality of sensors include an accelerometer, a magnetometer, and a global positioning system (GPS).

The system of any preceding clause, wherein the plurality of sensors include a gas leak sensor and a wind sensor.

The system of any preceding clause, wherein the plurality of sensors include a temperature sensor, a pressure sensor, a humidity sensor, or any combination thereof.

The system of any preceding clause, wherein the setup mode includes a connectivity mode followed by a self-calibration mode, the connectively mode is configured to guide a network connection with the monitoring tool, and the self-calibration mode is configured to collect the sensor data, obtain the calibration data, and calibrate the monitoring tool.

The system of any preceding clause, wherein the setup mode is configured to evaluate a tilt of the monitoring tool relative to a threshold during the first rotational movement of the monitoring tool, and request a mounting adjustment if the tilt exceeds the threshold.

The system of any preceding clause, wherein the plurality of sensors include a magnetometer, the sensor data includes magnetometer data from the magnetometer, the calibration data includes magnetometer calibration data for the magnetometer, and calibration of the monitoring tool includes calibration of the magnetometer based on the magnetometer calibration data.

The system of any preceding clause, wherein the magnetometer calibration data includes an iron interference compensation configured to compensate for hard and soft-iron interferences.

The system of any preceding clause, wherein the magnetometer calibration data includes a magnetic declination compensation configured to offset for a declination angle between magnetic North and true North at a location of the monitoring tool.

The system of any preceding clause, wherein plurality of sensors a global positioning system (GPS), and the setup mode is configured to determine the location of the monitoring tool based on GPS data from the GPS.

The system of any preceding clause, wherein the setup mode is configured to operate the magnetometer as a digital compass after calibration of the magnetometer, and the setup mode is configured to identify the true North orientation using the magnetometer as the digital compass.

The system of any preceding clause, wherein the setup mode is configured to guide positioning of the monitoring tool about the central axis of the mount based on the true North orientation.

The system of any preceding clause, wherein the power supply includes one or more solar panels, and the setup mode is configured to guide the positioning of the monitoring tool to face a cardinal point of maximum solar exposure of the one or more solar panels.

The system of any preceding clause, wherein the setup mode is configured to transmit the sensor data from the monitoring tool to one or more computing devices configured to generate the calibration data, wherein the one or more computing devices include a local computing device, a remote computing device, or a combination thereof. The setup mode is further configured to receive the calibration data at the monitoring tool from the one or more computing devices.

The system of any preceding clause, wherein the monitoring tool includes a user interface configured to initiate the setup mode, output feedback during the setup mode, or any combination thereof.

A tangible and non-transitory machine readable medium including instructions to operate a monitoring tool in a setup mode and a normal operational mode. The monitoring tool includes one or more sensors, a power supply, and a controller coupled to the one or more sensors and the power supply, wherein the controller has a processor, a memory, and instructions stored on the memory and executable by the processor. The setup mode is configured to collect sensor data during a first rotational movement of the monitoring tool about a central axis of a mount, obtain calibration data based on the sensor data, calibrate the monitoring tool based on the calibration data, and identify a true North orientation of the monitoring tool during a second rotational movement of the monitoring tool about the central axis of the mount.

The medium of the preceding clause, wherein the setup mode is configured to evaluate a tilt of the monitoring tool relative to a threshold during the first rotational movement of the monitoring tool, and request a mounting adjustment if the tilt exceeds the threshold.

The medium of any preceding clause, wherein the plurality of sensors include a magnetometer, the sensor data includes magnetometer data from the magnetometer, the calibration data includes magnetometer calibration data for the magnetometer, and calibration of the monitoring tool includes calibration of the magnetometer based on the magnetometer calibration data, wherein the setup mode is configured to operate the magnetometer as a digital compass after calibration of the magnetometer, wherein the setup mode is configured to identify the true North orientation using the magnetometer as the digital compass.

A method includes operating a monitoring tool in a setup mode and a normal operational mode. The monitoring tool includes one or more sensors, a power supply, and a controller coupled to the one or more sensors and the power supply, wherein the controller has a processor, a memory, and instructions stored on the memory and executable by the processor. The setup mode is configured to collect sensor data during a first rotational movement of the monitoring tool about a central axis of a mount, obtain calibration data based on the sensor data, calibrate the monitoring tool based on the calibration data, and identify a true North orientation of the monitoring tool during a second rotational movement of the monitoring tool about the central axis of the mount.

The method of the preceding clause, wherein the plurality of sensors include a magnetometer, the sensor data includes magnetometer data from the magnetometer, the calibration data includes magnetometer calibration data for the magnetometer, and calibration of the monitoring tool includes calibration of the magnetometer based on the magnetometer calibration data, wherein the setup mode is configured to operate the magnetometer as a digital compass after calibration of the magnetometer, wherein the setup mode is configured to identify the true North orientation using the magnetometer as the digital compass.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical.

1. A system, comprising:
a monitoring tool, comprising:
one or more sensors;
a power supply; and
a controller coupled to the one or more sensors and the power supply, wherein the controller has a processor, a memory, and instructions stored on the memory and executable by the processor to operate in a setup mode and a normal operational mode, wherein the setup mode is configured to:
collect sensor data during a first rotational movement of the monitoring tool about a central axis of a mount;
obtain calibration data based on the sensor data;
calibrate the monitoring tool based on the calibration data; and
identify a true North orientation of the monitoring tool during a second rotational movement of the monitoring tool about the central axis of the mount.

2. The system of claim 1, wherein the plurality of sensors comprise an accelerometer, a magnetometer, and a global positioning system (GPS).

3. The system of claim 1, wherein the plurality of sensors comprise a gas leak sensor and a wind sensor.

4. The system of claim 3, wherein the plurality of sensors comprise a temperature sensor, a pressure sensor, a humidity sensor, or any combination thereof.

5. The system of claim 1, wherein the setup mode comprises a connectivity mode followed by a self-calibration mode, the connectively mode is configured to guide a network connection with the monitoring tool, and the self-calibration mode is configured to collect the sensor data, obtain the calibration data, and calibrate the monitoring tool.

6. The system of claim 1, wherein the setup mode is configured to evaluate a tilt of the monitoring tool relative to a threshold during the first rotational movement of the monitoring tool, and request a mounting adjustment if the tilt exceeds the threshold.

7. The system of claim 1, wherein the plurality of sensors comprise a magnetometer, the sensor data comprises magnetometer data from the magnetometer, the calibration data comprises magnetometer calibration data for the magnetometer, and calibration of the monitoring tool comprises calibration of the magnetometer based on the magnetometer calibration data.

8. The system of claim 7, wherein the magnetometer calibration data comprises an iron interference compensation configured to compensate for hard and soft-iron interferences.

9. The system of claim 7, wherein the magnetometer calibration data comprises a magnetic declination compensation configured to offset for a declination angle between magnetic North and true North at a location of the monitoring tool.

10. The system of claim 9, wherein plurality of sensors comprises a global positioning system (GPS), and the setup mode is configured to determine the location of the monitoring tool based on GPS data from the GPS.

11. The system of claim 7, wherein the setup mode is configured to operate the magnetometer as a digital compass after calibration of the magnetometer, and the setup mode is configured to identify the true North orientation using the magnetometer as the digital compass.

12. The system of claim 1, wherein the setup mode is configured to guide positioning of the monitoring tool about the central axis of the mount based on the true North orientation.

13. The system of claim 12, wherein the power supply comprises one or more solar panels, and the setup mode is configured to guide the positioning of the monitoring tool to face a cardinal point of maximum solar exposure of the one or more solar panels.

14. The system of claim 1, wherein the setup mode is configured to:
transmit the sensor data from the monitoring tool to one or more computing devices configured to generate the calibration data, wherein the one or more computing devices comprise a local computing device, a remote computing device, or a combination thereof; and
receive the calibration data at the monitoring tool from the one or more computing devices.

15. The system of claim 1, wherein the monitoring tool comprises a user interface configured to initiate the setup mode, output feedback during the setup mode, or any combination thereof.

16. A tangible and non-transitory machine readable medium comprising instructions to:
operate a monitoring tool in a setup mode and a normal operational mode, wherein the monitoring tool comprises one or more sensors, a power supply, and a controller coupled to the one or more sensors and the power supply, wherein the controller has a processor, a memory, and instructions stored on the memory and executable by the processor, wherein the setup mode is configured to:
collect sensor data during a first rotational movement of the monitoring tool about a central axis of a mount;
obtain calibration data based on the sensor data;
calibrate the monitoring tool based on the calibration data; and
identify a true North orientation of the monitoring tool during a second rotational movement of the monitoring tool about the central axis of the mount.

17. The medium of claim 16, wherein the setup mode is configured to evaluate a tilt of the monitoring tool relative to a threshold during the first rotational movement of the monitoring tool, and request a mounting adjustment if the tilt exceeds the threshold.

18. The medium of claim 16, wherein the plurality of sensors comprise a magnetometer, the sensor data comprises magnetometer data from the magnetometer, the calibration data comprises magnetometer calibration data for the magnetometer, and calibration of the monitoring tool comprises calibration of the magnetometer based on the magnetometer calibration data, wherein the setup mode is configured to operate the magnetometer as a digital compass after calibration of the magnetometer, wherein the setup mode is configured to identify the true North orientation using the magnetometer as the digital compass.

19. A method, comprising:
operating a monitoring tool in a setup mode and a normal operational mode, wherein the monitoring tool comprises one or more sensors, a power supply, and a controller coupled to the one or more sensors and the power supply, wherein the controller has a processor, a memory, and instructions stored on the memory and executable by the processor, wherein the setup mode is configured to:
collect sensor data during a first rotational movement of the monitoring tool about a central axis of a mount;
obtain calibration data based on the sensor data;
calibrate the monitoring tool based on the calibration data; and
identify a true North orientation of the monitoring tool during a second rotational movement of the monitoring tool about the central axis of the mount.

20. The method of claim 19, wherein the plurality of sensors comprise a magnetometer, the sensor data comprises magnetometer data from the magnetometer, the calibration data comprises magnetometer calibration data for the magnetometer, and calibration of the monitoring tool comprises calibration of the magnetometer based on the magnetometer calibration data, wherein the setup mode is configured to operate the magnetometer as a digital compass after calibration of the magnetometer, wherein the setup mode is configured to identify the true North orientation using the magnetometer as the digital compass.
